(19) United States
(12) Patent Application Publication
(10) Pub. No.: US 2023/0279177 A1
(43) Pub. Date: Sep. 7, 2023

(54) RESIN COMPOSITION AND MANUFACTURING METHOD THEREOF

(71) Applicant: NAN YA PLASTICS CORPORATION, Taipei (TW)

(72) Inventors: Te-Chao Liao, TAIPEI (TW); Han-Ching Hsu, TAIPEI (TW); Chun-Lai Chen, TAIPEI (TW)

(73) Assignee: NAN YA PLASTICS CORPORATION, Taipei (TW)

(21) Appl. No.: 17/739,217

(22) Filed: May 9, 2022

(30) Foreign Application Priority Data
Mar. 3, 2022 (TW) 111107815

(51) Int. Cl. C08G 63/183; C08L 67/02; B29C 48/00; B29C 48/40; C08J 3/12

(52) U.S. Cl. CPC C08G 63/183; C08L 67/02; B29C 48/022; B29C 48/40; C08J 3/12; C08L 2203/30; C08L 2205/025; C08L 2207/20

(57) ABSTRACT

A resin composition suitable for profile extrusion processing is provided. Based on the total weight of the resin composition, the resin composition includes 40 wt. % to 92.1 wt. % of polyester; 2 wt. % to 15 wt. % of modifier, 0.2 wt. % to 1.5 wt. % of tackifier, and 0.1 wt. % to 40 wt. % of filler.

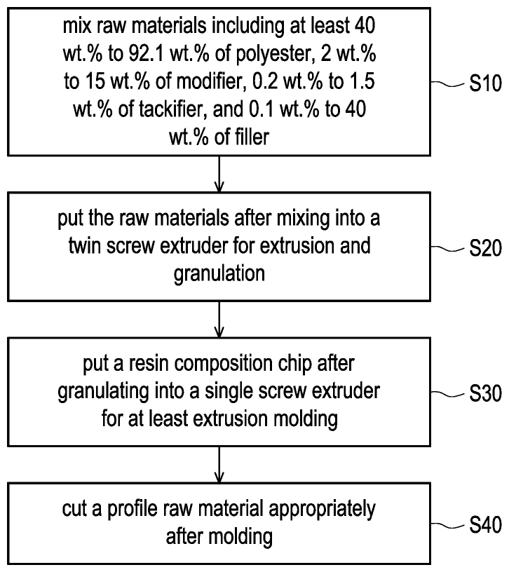

### CROSS-REFERENCE TO RELATED APPLICATION

This application claims the priority benefit of Taiwanese application serial no. 111107815, filed on Mar. 3, 2022. The entirety of the above-mentioned patent application is hereby incorporated by reference herein and made a part of this specification.

### BACKGROUND

### Technical Field

The disclosure relates to a resin composition and a manufacturing method thereof, and in particular to a resin composition suitable for profile extrusion processing and a manufacturing method thereof.

### Description of Related Art

Profile extrusion is an out-of-mold plastic processing process, which is different from injection molding, which is an in-mold plastic processing method. Compared to injection molding, profile extrusion could be adjusted according to customized product requirements.

In terms of materials used for profile extrusion, Polyvinyl Chloride (PVC) or Acrylonitrile Butadiene Styrene (ABS) resins are generally used because the corresponding materials need to have higher melt tension and/or higher melt flow in the profile extrusion process.

Polyester materials have been widely used in general household products, industrial products or commodities, such as: protective products, magnetic tapes, insulating tapes, photo films, tracing films, packaging films, electrical insulating films, and engineering paper. Therefore, how to use the polyester material in the profile extrusion process or the corresponding products, and even, the recycled polyester material will be introduced, has become a current research topic.

### SUMMARY

The disclosure provides a resin composition and a manufacturing method thereof, suitable for profile extrusion processing.

The resin composition of the disclosure is suitable for profile extrusion processing. Based on the total weight of the resin composition, the resin composition includes 40 wt. % to 92.1 wt. % of polyester; 2 wt. % to 15 wt. % of modifier, 0.2 wt. % to 1.5 wt. % of tackifier, and 0.1 wt. % to 40 wt. % of filler.

The manufacturing method of the resin composition of the disclosure includes the following steps. Raw materials including at least 40 wt. % to 92.1 wt. % of polyester, 2 wt. % to 15 wt. % of modifier, 0.2 wt. % to 1.5 wt. % of tackifier, and 0.1 wt. % to 40 wt. % of filler are mixed. The raw materials after mixing are put into a twin screw extruder for extrusion and granulation to form the resin composition suitable for profile extrusion processing.

Based on the above, the resin composition of the disclosure may be suitable for profile extrusion processing by the composition and/or corresponding manufacturing method.

To make the aforementioned more comprehensible, several accompanied with drawings are described in detail as follows.

### BRIEF DESCRIPTION OF THE DRAWING

The accompanying drawings are included to provide a further understanding of the disclosure, and are incorporated in and constitute a part of this specification. The drawings illustrate exemplary embodiments of the disclosure and, together with the description, serve to explain the principles of the disclosure.

The FIGURE is a partial schematic flowchart of a manufacturing method of a resin composition according to an embodiment of the disclosure.

### DESCRIPTION OF THE EMBODIMENTS

In the following detailed description, for the sake of explanation and not limitation, exemplary embodiments revealing specific details are set forth to provide a thorough understanding of various principles of the invention. However, it will be apparent to those skilled in the art that, benefit from the disclosure, the invention may be practiced in other embodiments that depart from the specific details disclosed herein. In addition, descriptions of well-known devices, methods, and materials may be omitted so as not to obscure the description of various principles of the invention.

A range may be expressed herein as from “about” a specific value to “about” another specific value, and it may also be directly expressed as a specific value and/or to another specific value. When expressing the range, another embodiment includes from the one specific value and/or to another specific value. Similarly, when a value is expressed as an approximation by using the antecedent “about,” it will be understood that the specific value forms another embodiment. It will be further understood that an endpoint of each range is apparently related to or independent from another endpoint.

In the specification, non-limiting terms (such as possible, may, for example or other similar terms) are non-essential or optional implementation, inclusion, addition or existence.

Unless otherwise defined, all terms (including technical terms and scientific terms) used herein have the same meanings as commonly understood by those with ordinary knowledge in the technical field to which the invention belongs. It will also be understood that terms (such as those defined in commonly used dictionaries) should be interpreted as having a meaning consistent with the meaning in the relevant technical background and should not be interpreted in an idealized or overly formal sense, unless explicitly defined herein.

In this embodiment, a resin composition may be suitable for profile extrusion processing. Based on the total weight of the resin composition, the resin composition includes: 40 wt. % to 92.1 wt. % of polyester, 2 wt. % to 15 wt. % of modifier, 0.2 wt. % to 1.5 wt. % of tackifier, and 0.1 wt. % to 40 wt. % of filler.

In an embodiment, based on the total weight of the resin composition, the resin composition may further include 0.1 wt. % to 1.0 wt. % of antioxidant.

In an embodiment, based on the total weight of the resin composition, the resin composition may further include 0.1 wt. % to 1.0 wt. % of slipping agent, 0.15 wt. % to 5.0 wt. % of weather-resistant agent, and 0.1 wt. % to 40 wt. % of filler.

[Polyester]

It should be noted that the term “polyester” (or similar terms such as “polyester material”) herein refers to any type of polyester, especially aromatic polyesters.

Moreover, the polyester herein may also be, for example, polytrimethylene terephthalate (PTT), polybutylene terephthalate (PBT), polyethylene naphthalate (PEN), or a combination of the foregoing. In the present embodiment, the polyester is preferably polyethylene terephthalate (PET), polytrimethylene terephthalate (PPT), or a combination of the above. Furthermore, a copolymer may also be used, which specifically refers to a copolymer that may be obtained by using two or more dicarboxylic acids and/or two or more diol components.

Preferably, the polyester herein includes polyesters derived from terephthalic acid (PTA) and ethylene glycol (EG) (i.e., polyethylene terephthalate (PET)).

In an embodiment, the polyester used in the resin composition of the disclosure may be in the form of granules, which may be referred to as polyester chips.

In an embodiment, the polyester used in the resin composition of the disclosure may include virgin polyester, recycled polyester, or a combination of the above.

[Recycled Polyester Material]

A method of recycling the polyester material include the followings. Various types of waste polyester materials are collected. The waste polyester materials may be classified according to the type, color and/or use to which they have been put. Then, the waste polyester materials after sorting may be compressed and packaged. Afterwards, the waste polyester materials after packaging may be transported to a waste treatment plant. The waste polyester materials may include, for example, recycled PET bottles, but the disclosure is not limited thereto.

The method of recycling the polyester material may further include the following. Objects (e.g., bottle caps, labels and/or adhesives) are removed from the waste polyester materials. Next, the waste polyester materials are physically and mechanically crushed. Then, the polyester materials after crushing are separated out using an appropriate method (e.g., flotation). After that, the waste polyester materials after crushing and separating are dried to obtain processed recycled polyester materials.

In an embodiment, the recycled polyester materials may also include, for example, processed recycled polyester materials through direct purchase.

In an embodiment, the recycled polyester materials may also be recycled waste from a processing process (e.g., edge trims or other similar excess materials after being removed during the process). Such recycled materials are often referred to as industrial recycled materials.

The recycled polyester materials obtained by the above method may be further formed into recycled polyester chips by way of the following.

[Forming of Physical Recycled Polyester Material]

In an embodiment, the recycled polyester materials may be melted such that it appears in a molten state. Then, the melt may be filtered through a filter so as to remove possible solid impurities. After that, an extruder (such as a commercially available single screw extruder; SSE), twin screw extruder (TSE) or other similar screw extruders (but not limited thereto) may be used so as to extrude and granulate the melt to form physical recycled polyester materials.

In an embodiment, before the recycled polyester materials are melted, the recycled polyester materials may be formed into the form of powder or granular by cutting, clipping, trimming, or other physical means, so as to reduce the time and/or energy consumption required for melting.

On the other hand, the aforementioned method is to reshape the recycled polyester materials through the steps of cutting, melting, filtering and extruding. In other words, in general, physical recycled polyester materials are made by rearranging polyester molecules in the recycled polyester materials.

In the present embodiment, since in the aforementioned physical remanufacturing process, the polyester molecules are generally only rearranged (that is, basically not reorganized), the components originally present in the recycled polyester material (such as additives, slipping agents, stabilizers and/or polymerization catalysts) will still be present in a physical recycled polyester material. In other words, some of the characteristics of the physical recycled polyester materials may be the same or similar to some of the characteristics of the originally used recycled polyester materials.

The physical recycled polyester materials produced by the aforementioned physical remanufacturing usually have a relatively high intrinsic viscosity (as compared to chemical recycled polyester materials described later). In the present embodiment, the intrinsic viscosity of the physical recycled polyester materials are usually not less than 0.60 dL/g; for example, it may be between 0.65 dL/g and 0.95 dL/g; for example, it may be further between 0.75 dL/g and 0.85 dL/g; for example, it may be about 0.80 dL/g. In an embodiment, the intrinsic viscosity of the physical recycled polyester materials may be adjusted through solid-state polymerization. However, by solid-state polymerization, the intrinsic viscosity of the physical recycled polyester materials may be easily increased, but cannot be reduced.

[Formation of Chemical Recycled Polyester Material]

Step 1-1: In an embodiment, the recycled polyester materials may be chemically depolymerized. For example, the recycled polyester materials and depolymerization liquid may be put into a depolymerization tank for chemical depolymerization.

In general, the chemical depolymerization solution may sever the polyester molecules in the recycled polyester material, thereby achieving the effect of depolymerization. Moreover, a polyester composition with a shorter molecular chain and/or an ester monomer composed of a diacid unit (e.g., terephthalic acid) and multiple diol units (1,4-butanediol, polytetramethylene ether glycol, or a combination thereof; or, ethylene glycol, polytetramethylene ether glycol, or a combination thereof) may be obtained. That is, an average molecular weight of the mixture after chemical depolymerization is generally smaller than an average molecular weight of the recycled polyester material.

Furthermore, the disclosure does not limit the type of depolymerization solution. For example, hydrolysis may be performed by water. For another example, alcohols (such as methanol, ethanol, ethylene glycol, diethylene glycol, 1,4-butanediol, or a mixture of the above) may be used for alcoholysis.

In an embodiment, the depolymerization solution is preferably alcohol. Alcohols that can be used to produce the reaction monomer for virgin chips are generally preferred. For example, ethylene glycol may be used as the depolymerization solution.

When the chemical depolymerization reaction is performed, a heating step may be appropriately performed. In general, the rate of a chemical reaction increases with temperature. For example, the recycled polyester material and alcohols may be put into the depolymerization tank for the alcoholysis reaction at a temperature of 200° C. to 230° C. for about three hours.

Step 1-2: esterification reaction is proceeded.

The product after the aforementioned chemical depolymerization reaction is subjected to an esterification reaction. It is worth noting that in the disclosure, not all polyester materials need to be completely depolymerized.

For example, the product after the aforementioned chemical depolymerization reaction may be transferred to an esterification tank for esterification reaction. The esterification reaction is generally a reversible reaction. Therefore, during the esterification reaction, the depolymerization solution and/or part of the products (such as alcohol and/or water) may be brought out by distillation. In this way, the amount or concentration of other products (such as polyester products) may be increased through the chemical equilibrium of chemical reactions.

In an embodiment, the product after the aforementioned chemical depolymerization reaction may be first filtered by a filter before being moved into the esterification tank, such that at least part of the impurities may be eliminated, thereby reducing the concentration of non-polyester impurities. In an embodiment, the pore size of the filter may be between 1 μm and 10 μm.

In a possible embodiment, after the aforementioned esterification reaction proceeds for a period of time, suitable or appropriate additives may be added to the esterification tank, but the disclosure is not limited thereto. Other additives may include antioxidants, stabilizers and/or polymerization catalysts.

Step 1-3: polymerization reaction is proceeded.

The product after the aforementioned esterification reaction is subjected to a polymerization reaction.

For example, the product after the aforementioned esterification reaction may be moved into a polymerization tank for polymerization reaction.

The aforementioned polymerization reaction may include a prepolymerization reaction and/or a main polymerization reaction.

The prepolymerization reaction is, for example, to reduce the gas pressure in the tank within a period of time. For example, by pumping gas (e.g., air), the gas pressure in the tank may be reduced from normal pressure (such as about 760 torr) to 10 torr within 60 minutes; or, further drop below 10 torr (such as to 1 torr or close to 1 torr).

The main polymerization reaction is, for example, to heat the material in the tank under low pressure (for example, lower than the room pressure/normal pressure). For example, the polymerization reaction may be carried out at a temperature of 280° C. under the condition that the gas pressure in the tank is below 1 torr.

Step 1-4: chemical recycled polyester material is formed.

The aforementioned polymerization reaction is proceeded until the substance in the tank has the corresponding intrinsic viscosity. Then, the gas pressure in the tank may be increased (for example, by filling nitrogen gas). Afterwards, the material in the tank is extruded and/or pelletized by the usual granulation method of general polymer chips to form the chemical recycled polyester material.

In this embodiment, the chemical recycled polyester materials produced by the aforementioned chemical remanufacturing usually have a relatively low intrinsic viscosity (as compared to physical recycled polyester materials described previously). In this embodiment, the intrinsic viscosity is usually not less than 0.65 dL/g; preferably, it may be between 0.65 dL/g and 0.95 dL/g; better yet, it may be further between 0.75 dL/g and 0.85 dL/g; for example, it may be about 0.80 dL/g.

[Formation of Recycled Polyester Material]

The physical recycled polyester material and the chemical recycled polyester material may be mixed to form a recycled polyester material with a predetermined intrinsic viscosity. Compared with the physical recycled polyester material, the chemical recycled polyester material has higher process costs and/or longer manufacturing time. Compared with the chemical recycled polyester material, the material characteristics of the physical recycled polyester material (e.g., intrinsic viscosity, but not limited thereto) are more difficult to adjust. Thus, by mixing the physical recycled polyester material with the chemical recycled polyester material, the process cost of the recycled polyester material may be reduced and/or the manufacturing time may be shortened, and the material characteristics may still be adjusted appropriately.

In an embodiment, the physical recycled polyester material and the chemical recycled polyester material in the form of powder or granular may be directly mixed according to an appropriate ratio to form the recycled polyester material.

In an embodiment, the physical recycled polyester material and the chemical recycled polyester material may be formed into the recycled polyester material by granulating steps of melting and extrusion in an extruder.

In an embodiment, the characteristics of the recycled polyester material may fall between those of the physical recycled polyester material and the chemical recycled polyester material. For example, the intrinsic viscosity of the recycled polyester material may have a corresponding linear relationship according to a ratio of the physical recycled polyester material to the chemical recycled polyester material and the intrinsic viscosity.

In an embodiment, the polyester (or the polyester material) used in the resin composition may include the recycled polyester (or the recycled polyester material). In an embodiment, the recycled polyester (or the recycled polyester material) used in the resin composition may include the physical recycled polyester (or the physical recycled polyester material) and the chemical recycled polyester (or the chemical recycled polyester material).

[Manufacturing Method of Virgin Polyester Chips]

The manufacturing may be done by the same or similar method to the [Formation of chemical recycled polyester material], with the difference that the terephthalic acid and the ethylene glycol may be directly added to the esterification tank for esterification reaction.

In this embodiment, the intrinsic viscosity of the virgin polyester chips formed by the above-mentioned method is usually not more than 0.65 dL/g; for example, it may be between 0.65 dL/g and 0.95 dL/g; for example, it may be further between 0.75 dL/g and 0.85 dL/g; for example, it may reach 0.80 dL/g.

In an embodiment, the polyester particles formed by the above method can be called virgin polyester chips (virgin polyester chips).

In a possible embodiment, after the aforementioned esterification reaction proceeds for a period of time, suitable or appropriate additives may be added to the esterification tank, but the disclosure is not limited thereto.

[Modifier]

In order to improve the physical characteristics of the resin composition, a modifier with better compatibility with polyester may be added. In addition, the addition of the modifier may be used to adjust high temperature processing melt viscosity and improve flowability of polyester-containing resin composition so that non-solid (which may include molten or semi-molten) resin composition may adhere to the processing equipment during the extrusion processing. Moreover, the addition of the modifier may also improve physical toughness and/or tear strength of the resin composition suitable for profile extrusion processing.

In an embodiment, the modifier may include alkene monomer, alkene copolymer, or polyolefin.

In an embodiment, the modifier may include ethylene-propylene-diene monomer (EPDM) grafted with glycidyl methacrylate (GMA) (EPDM-g-GMA or EPDM-GMA), poly(ethylene octene) grafted with glycidyl methacrylate (POE-g-GMA or POE-GMA), ethylene-propylene-diene monomer (EPDM), Styrene-butadiene-styrene copolymer (SBS), styrene-ethylene-butylene-styrene copolymer (SEBS), Polyolefin elastomer (POE), Polyolefin elastomer grafted with maleic anhydride (POE-g-MA or POE-MA), or a combination thereof, but the disclosure is not limited thereto.

[Tackifier]

To increase the intrinsic viscosity of the resin composition, a tackifier may be used. But it should be noted that if too much tackifier is added (e.g., based on the total weight of the resin composition, the proportion of the tackifier is greater than or equal to 1.5 wt. % or greater than 1.0 wt. %), the non-solid (which may include molten or semi-molten) resin composition may easily adhere to the processing equipment during the extrusion processing.

In an embodiment, the tackifier may include epoxy (EP), isocyanate, anhydride, oxazoline, or a combination thereof, but the disclosure is not limited thereto.

In an embodiment, the epoxy used as tackifier can be a resin product manufactured by BASF Corporation, model number ADR 4380.

In an embodiment, the isocyanate as tackifier may include toluene diisocyanate (TDI), Methylene diphenyl diisocyanate (MDI), Hexamethylene diisocyanate (HDI), Isophorone diisocyanate (IPDI), dicyclohexylmethane diisocyanate (4,4′-diisocyanato dicyclohexylmethane (HMDI), or a combination thereof, but the disclosure is not limited thereto.

In an embodiment, the anhydride as tackifier may include 1,4,5,8-Naphthalenetetracarboxylic dianhydride (NTDA), Pyromellitic dianhydride (PMDA), or a combination thereof, but the disclosure is not limited thereto.

In an embodiment, the oxazoline as tackifier may include 2,2′-bis(2-oxazoline) (BOZ), 1,3-Bis(4,5-dihydro-2-oxazolyl)benzene (PBO), or a combination thereof, but the disclosure is not limited thereto.

[Antioxidant]

In the process of polymer formation or use, polymer degradation or unintended reactions may occur due to heat, high-energy radiation (e.g., UV irradiation), mechanical stress, catalyst residue, reaction with other impurities, contact with oxidants during use, or other possibilities. The polymer degradation or unintended reactions may be caused by the generation of peroxy radicals and other possible free radicals or peroxides in the polymer or the product from which it is made, possibly due to heat, high energy radiation, mechanical stress, or other causes. The free radicals or peroxides may react with oxygen in the air or water vapor to produce more free radicals/peroxides, which in turn may trigger a vicious cycle of reactions. The result of the vicious cycle of reactions may make the polymer or the product from which it is made vulnerable to damage (e.g., cracking, breakage, or discoloration), which may reduce or lose its original physical characteristics.

Therefore, it may be possible to inhibit the proceeding of the vicious cycle of reactions by the addition of the antioxidant. The reason may be: to make it (i.e., the antioxidant) react with the free radicals or peroxides to reduce the possibility of the vicious cycle of reactions.

It should be noted that if too much antioxidant is added (e.g., based on the total weight of the resin composition, the proportion of the antioxidant is greater than or equal to 2 wt. % or greater than 1.0 wt. %), the color deviation of the resin composition may be too great in appearance.

In an embodiment, the antioxidant may include phenolic compounds, amine compounds, phosphorous compounds, thioester compounds, or a combination thereof.

In one example, the antioxidant may be used with commercially available products under the trade names/trademarks Irganox 1010, Irganox 1425, Irganox 245, Anox 1315, Anox PP18, Anox 20, Lowinox 1790, Lowinox TBM-68, Naugard 445, Sandostab P-EPQ, Irgafos 168, or Naugard 412S.

[Slipping Agent]

In the manufacturing process of the resin composition and/or during processing (e.g. extrusion), the slipping agent may reduce the possibility of adhesion to the processing equipment and the generation of gas spots/bubbles.

In an embodiment, the slipping agent may include fatty acids, fatty acid esters, fatty alcohols, paraffin oils, or a combination thereof, selected from a carbon number of 20 or more (i.e., C20 or more). Preferably, the slipping agent may include fatty acids or fatty acid esters having a carbon number of 28 to 32 (i.e., C28 to C32).

[Weather-Resistant Agent]

In an embodiment, the weather-resistant agent may include benzotriazole with hydroxyl and/or phenyl groups, hydroxy benzophenone, silicon oxide, titanium dioxide, aluminum hydroxide, aluminum oxide, magnesium hydroxide, magnesium oxide, magnesium phosphate, magnesium sulfate, magnesium carbonate, zinc borate, zinc oxide, zinc sulfide, boron oxide, boron phosphate, calcium borate, calcium carbonate, calcium hydroxide, barium sulfate, or a combination thereof.

In a preferred embodiment, the weather-resistant agent is selected from the group consisting of titanium dioxide, calcium carbonate, and barium sulfate. More preferably, the weather-resistant agent is titanium dioxide. This not only gives the polymer or the product from which it is made good weather resistance, but also gives the polymer or the product from which it is made a white color without the need for additional colorants.

In a preferred embodiment, the weather-resistant agent is selected from the group consisting of benzotriazole with hydroxyl and/or phenyl groups and hydroxy benzophenone. Benzotriazole with hydroxyl and/or phenyl groups may include, but are not limited to 2-(2′-hydroxy-3′,5′-di-pentylphenyl)benzotriazole (2-(2H-benzotriazol-2-yl)-4,6-ditertpentylphenol; CAS: 25973-55-1; commercially available product under the trade name/trademark UV-328), 2,4-di-tert-butyl-6-(5-chlorobenzotriazol-2-yl)phenol (CAS: 3864-99-1; commercially available product under the trade name/trademark UV-327), 2-(2′-hydroxy-3′-isobutyl-5′-tert-butylphenyl)benzotriazole (2-(2H-benzotriazol-2-yl)-4-(tert-butyl)-6-(sec-butyl)phenol; CAS: 36437-37-3; commercially available product under the trade name/trademark UV-350) or 2-(2′-hydroxy-3′,5′-di-tert-butylphenyl)-benzotriazole (2-benzotriazol-2-yl-4,6-di-tert-butylphenol; CAS: 3846-71-7; commercially available product under the trade name/trademark UV-320). The hydroxy benzophenone may include but is not limited to 2-hydroxybenzophenone or 4-hydroxybenzophenone. The benzotriazole with hydroxyl and/or phenyl groups or hydroxy benzophenone may be used as UV absorbers. In this way, the polymer or the product from which it is made may have good weather resistance under UV light (e.g., in natural sunlight).

[Filler]

In processed parts made by the resin composition, a filler added to the resin composition may enhance the mechanical strength, wear resistance and/or non-flammability of the processed parts.

In an embodiment, the filler may be selected from one or more of metal hydroxides such as glass fiber, talc powder, calcium carbonate, mica powder, limestone, silica powder, magnesium hydroxide, or aluminum hydroxide, and the filler may be particles with an average particle diameter of 0.01 to 100 μm.

[Manufacturing Method of Resin Composition]

A manufacturing method of the resin composition is exemplarily described as follows.

Step 1: the following raw materials in parts by weight are weighed: 40 wt. % to 92.1 wt. % of polyester, 2 wt. % to 15 wt. % of modifier, and 0.2 wt. % to 1.5 wt. % of tackifier.

In an embodiment, the following raw materials in parts by weight may be further weighed: 0.1 wt. % to 1.0 wt. % of antioxidant.

In an embodiment, the following raw materials in parts by weight may be further weighed: 0.1 wt. % to 1.0 wt. % of slipping agent, 0.15 wt. % to 5.0 wt. % of weather-resistant agent, and 0.1 wt. % to 40 wt. % of filler.

Step 2: after being mixed in proportion, the raw materials are stirred in a mixer for a suitable time (e.g., 5 to 30 minutes) and then put into the twin screw extruder. Moreover, a corresponding resin composition chip may be formed by extruding and granulating in the twin screw extruder.

In an embodiment, the viscosity of the resin composition (or the resin composition chip) may be between 300 Pa·s and 500 Pa·s. If the viscosity of the resin composition is too high (e.g., greater than 500 Pa.$), it may have to be obtained by solid state polymerization or other viscosity enhancement methods, which may require excessive energy consumption.

In an embodiment, the twin screw extruder may have one or more heating sections. The temperature of each of the heating sections is about 200° C. to 270° C. The number of the heating sections, the corresponding temperature, and the heating speed may be adjusted according to the design requirements. For example, the twin screw extruder may have five heating sections. The temperature of a first heating section is about 200° C. to 230° C., the temperature of a second heating section is about 220° C. to 250° C., the temperature of a third heating section is about 230° C. to 265° C., the temperature of a fourth heating section is about 230° C. to 260° C., and the temperature of a fifth heating section is about 230° C. to 265° C. The screw speed is about 180 rpm to 220 rpm. A ratio of L/D of a screw length (L) and a screw diameter (D) is between 36 and 52.

Step 3: the resin composition chip is put into the single screw extruder to form a corresponding profile raw material. The profile raw material may be formed into corresponding profile material by suitable forming and extrusion, cooling and/or cutting. The shape, appearance and/or dimensions of the profile material may be adjusted according to the requirements and are not limited in this disclosure. For example, the profile material may include strips, flat sheets, round tubes, square tubes or other suitable profile extrusion materials.

In an embodiment, the excess material left over from the material cutting may be recycled (i.e., referred to as industrial recycling material) and may be recycled by the aforementioned means.

### Examples and Comparative Examples

The disclosure is specifically described in the following examples and comparative examples, and the disclosure is not at all limited by the following examples.

Each example and comparative example can be formed by the above-mentioned way to form the corresponding resin composition chip and/or profile material. The difference lies in: adjusting the proportion of each composition used.

In the following examples and comparative examples, the evaluation method or standard can be as follows.

Impact strength: according to ASTM D 256 test standard. Sample size (mm): (63.5±2)×(12.7±0.2)×(3.2±0.2); notch angle 45±0.12, radius 0.25±0.12 mm, notch depth 10.16±0.05 mm.

Stretch strength (or tensile Strength): tested according to ASTM D638 test standard. Sample size (mm): (165±2)×(19±0.2)×(3.2±0.2), the stretch speed is 50 mm/min.

Flexural modulus: tested according to ASTM D 790 test standard. Sample type sample size (mm): (127±2)×(12.7±0.2)×(3.2±0.2), the flexural speed is 13 mm/min.

Heat deflection temperature: tested according to ASTM D648. Sample size (mm): (127±2)×(12.7±0.2)×(3.2±0.2); the heating rate is 120° C./hr, the pressure is 1.82 MPa (4.6 kg/cm²), and the set deformation is 0.254 mm.

Viscosity at 260° C.: after viscosity enhancement, the viscosity of the compounded resin is measured at 260° C. ambient atmosphere.

[Table 1]

TABLE 1

| | | | | Comparative | Comparative | Comparative |
|---|---|---|---|---|---|---|
| | Example 1 | Example 2 | Example 3 | Example 1 | Example 2 | Example 3 |
| Proportion of virgin | 0.00 | 57.00 | 0.00 | 86.90 | 86.30 | 0.00 |
| polyester (wt. %) | | | | | | |
| Proportion of | 0 | 0 | 20 | 0 | 0 | 0 |
| chemical recycled | | | | | | |
| polyester in recycled | | | | | | |
| chips (wt. %) | | | | | | |
| Proportion of | 100 | 0 | 80 | 0 | 0 | 100 |
| physical recycled | | | | | | |
| polyester in recycled | | | | | | |
| chips (wt. %) | | | | | | |
| Total proportion of | 57.00 | 0.00 | 56.70 | 0 | 0 | 87.00 |
| recycled chips (wt. %) | | | | | | |
| Proportion of | 12 | 12 | 12 | 12 | 0 | 12 |
| modifier (wt. %) | | | | | | |
| Proportion of | 0.60 | 0.60 | 0.60 | 0 | 0.30 | 0.60 |
| tackifier (wt. %) | | | | | | |
| Proportion of | 0.20 | 0.20 | 0.20 | 0.20 | 0.20 | 0.20 |
| antioxidant (wt. %) | | | | | | |
| Proportion of slipping | 0.20 | 0.20 | 0.20 | 0.20 | 0.20 | 0.20 |
| agent (wt. %) | | | | | | |
| Proportion of | 0 | 0 | 0.30 | 0 | 0 | 0 |
| weather-resistant | | | | | | |
| agent (wt. %) | | | | | | |
| Proportion of filler | 30 | 30 | 30 | 0 | 0 | 0 |
| (wt. %) | | | | | | |
| Impact strength (kg- | 4.3 | 4.0 | 4.2 | 13.9 | 3.1 | 13.8 |
| cm/cm) | | | | | | |
| Stretch strength | 46.0 | 42.8 | 45.2 | 39.1 | 42.9 | 42.8 |
| (MPa) | | | | | | |
| Flexural modulus | 3662.2 | 3289.3 | 3765.4 | 1890.5 | 2598.1 | 1764.7 |
| (MPa) | | | | | | |
| Heat deflection | 73.0 | 73.0 | 73.0 | 65.0 | 76.0 | 69.0 |
| temperature 1.8 MPa | | | | | | |
| (° C.) | | | | | | |
| Viscosity at 260° C. | 1786.0 | 1685.0 | 1698.0 | 570.0 | 870.0 | 1867.0 |
| (η*; Pa · s) | | | | | | |
| profile extrusion | good | good | good | bad | bad | available |
| processability | | | | (insufficient | (insufficient | |
| | | | | melt | melt | |
| | | | | strength) | strength) | |

As shown in each example and comparative example in [Table 1], the addition of the filler may reduce the impact strength (e.g., the impact strength is about 4.0 kg-cm/cm). On the contrary, if no filler is added, the impact strength is higher (e.g., the impact strength is about 13 kg-cm/cm or more).

As shown in each example and comparative example in [Table 1], the stretch strength may be maintained by adding further filler in addition to adding the appropriate proportion of tackifier.

As shown in each example and comparative example in [Table 1], the stretch strength may be maintained by adding further weather-resistant agent in addition to adding the appropriate proportion of tackifier.

As shown in each example and comparative example in [Table 1], the heat deflection temperature is slightly increased under the condition of adding the appropriate proportion of tackifier.

As shown in each example and comparative example in [Table 1], after viscosity enhancement, the viscosity of the compounded resin is measured at 260° C. ambient atmosphere in a range that allows for profile extrusion processing (e.g., greater than 1000 Pa·s or more suitable for profile extrusion processing: 1685 Pa·s±10%).

In summary, the resin composition of the disclosure may be suitable for profile extrusion processing. Additionally, the polyester used in the resin composition of the disclosure suitable for profile extrusion processing may include recycled polyester, and therefore is possible to be more environmentally friendly.

### INDUSTRIAL APPLICABILITY

The resin composition formed by the resin composition manufacturing method of the aforementioned embodiments of the disclosure may be directly or indirectly applied to a profile extrusion processing process or a profile extrusion processing product, and may be further processed into other livelihood, industrial or suitable products, including but not limited to building materials, stationery, toys, decoration, furniture, medical equipment, lighting, household electrical appliances, etc.

It will be apparent to those skilled in the art that various modifications and variations can be made to the disclosed without departing from the scope or spirit of the disclosure. In view of the foregoing, it is intended that the disclosure covers modifications and variations provided that they fall within the scope of the following claims and their equivalents.

What is claimed is:

1. A resin composition suitable for profile extrusion processing, wherein based on the total weight of the resin composition, the resin composition comprises:
40 wt. % to 92.1 wt. % of polyester;
2 wt. % to 15 wt. % of modifier;
0.2 wt. % to 1.5 wt. % of tackifier; and
0.1 wt. % to 40 wt. % of filler.

2. The resin composition according to claim 1, wherein the polyester comprises polyethylene terephthalate.

3. The resin composition according to claim 1, wherein the polyester comprises recycled polyester.

4. The resin composition according to claim 3, wherein the polyester comprises physical recycled polyester and chemical recycled polyester.

5. The resin composition according to claim 1, wherein the modifier comprises alkene monomer, alkene copolymer, polyolefin, or a combination thereof.

6. The resin composition according to claim 1, wherein the tackifier comprises epoxy, isocyanate, anhydride, oxazoline, or a combination thereof.

7. The resin composition according to claim 1, wherein based on the total weight of the resin composition, the resin composition further comprises:
0.1 wt. % to 1.0 wt. % of antioxidant.

8. The resin composition according to claim 7, wherein based on the total weight of the resin composition, the resin composition further comprises:
0.1 wt. % to 1.0 wt. % of slipping agent;
0.15 wt. % to 5.0 wt. % of weather-resistant agent; and
0.1 wt. % to 40 wt. % of filler.

9. A manufacturing method of a resin composition suitable for profile extrusion processing, comprising:
mixing raw materials comprising at least 40 wt. % to 92.1 wt. % of polyester, 2 wt. % to 15 wt. % of modifier, 0.2 wt. % to 1.5 wt. % of tackifier, and 0.1 wt. % to 40 wt. % of filler; and
putting the raw materials after mixing into a twin screw extruder for extrusion and granulation to form the resin composition suitable for profile extrusion processing.
